(19) United States
(12) Patent Application Publication
(10) Pub. No.: US 2025/0209349 A1
(43) Pub. Date: Jun. 26, 2025

(54) REMARK PREDICTIONS

(71) Applicant: INTERNATIONAL BUSINESS MACHINES CORPORATION, ARMONK, NY (US)

(72) Inventors: Xiao Xia Mao, Shanghai (CN); Jun Ming Guan, Shanghai (CN); Chun Hong Zheng, Beijing (CN); Nan Nan Li, Shanghai (CN); Ying Li, Shanghai (CN); Min Huang, Shanghai (CN); Jonathan D. Dunne, Dungarvan (IE)

(21) Appl. No.: 18/391,851

(22) Filed: Dec. 21, 2023

(51) Int. Cl. G06N 5/022; G06Q 10/1093

(52) U.S. Cl. CPC G06N 5/022; G06Q 10/1095

(57) ABSTRACT

A method, computer system, and a computer program product for remark predictions is provided. The present invention may include processing real-time communications data associated with a virtual meeting application. The present invention may also include predicting, based on a selected data included in the real-time communications data, that a subsequent data to be received in the real-time communications data will include an objectionable content. The present invention may further include executing a user interface (UI) action in the virtual meeting application to mitigate an impact of the subsequent data including the objectionable content.

### BACKGROUND

The present invention relates generally to the field of computing, and more particularly to collaborative computing sessions.

Virtual meetings have become a staple mode of remote collaborations. A virtual meeting may be supported by a network of servers and client computers and allow web-connected computer users to communicate via a communication network over geographically distant locations. Participants in a virtual meeting may join an online meeting session to take part in texting, video conferencing, virtual whiteboarding, and screen sharing activities. These online meeting sessions may enable data streams of text, audio and/or video signals to be communicated between participant devices in real-time. User experience (UX) is integral to the success of a virtual meeting product or service. Exceptional UX may enhance efficiencies in virtual meetings and help maintain healthy collaborative computing environments.

### SUMMARY

Embodiments of the present invention disclose a method, computer system, and a computer program product for remark predictions. The present invention may include processing real-time communications data associated with a virtual meeting application. The present invention may also include predicting, based on a selected data included in the real-time communications data, that a subsequent data to be received in the real-time communications data will include an objectionable content. The present invention may further include executing a user interface (UI) action in the virtual meeting application to mitigate an impact of the subsequent data including the objectionable content.

### BRIEF DESCRIPTION OF THE SEVERAL VIEWS OF THE DRAWINGS

These and other objects, features and advantages of the present invention will become apparent from the following detailed description of illustrative embodiments thereof, which is to be read in connection with the accompanying drawings. The various features of the drawings are not to scale as the illustrations are for clarity in facilitating one skilled in the art in understanding the invention in conjunction with the detailed description. In the drawings:

FIG. 1 illustrates a networked computing environment according to at least one embodiment;

FIG. 2 is a schematic block diagram of a model training environment according to at least one embodiment;

FIG. 3 is a schematic block diagram of a virtual meeting environment according to at least one embodiment;

FIG. 4 is a schematic block diagram of a generalized remark prediction model according to at least one embodiment; and

FIG. 5 is an operational flowchart illustrating a remark prediction process according to at least one embodiment.

### DETAILED DESCRIPTION

The following described exemplary embodiments provide a system, method, and computer program product for remark prediction. As such, the present embodiment has the capacity to improve the technical field of collaborative computing by combining corpus linguistics analysis and discrete event sequencing to predict whether a next utterance of a user (e.g., meeting participant) will be objectionable before delivery of the next utterance. The prediction may be determined based on a current utterance of the user and a custom linguistic model indicating the linguistic patterns of the user. More specifically a collaboration program may generate a remark prediction model for a user based on the user's historical communications data (e.g., prior meeting transcript data and chat utterances data). Then, the collaboration program may use the remark prediction model to predict objectionable remarks (e.g., before the objectionable remarks are uttered by the user) based on a current remark. Thereafter, the collaboration program may execute one or more actions to mitigate an impact of the objectionable remarks on the other meeting participants. It is contemplated that the remark prediction model may be generalized across various linguistic styles. It is further contemplated that the remark prediction model may be calibrated to detect and classify other types of remarks.

As described previously, virtual meetings have become a staple mode of remote collaborations. A virtual meeting may be supported by a network of servers and client computers and allow web-connected computer users to communicate via a communication network over geographically distant locations. Participants in a virtual meeting may join an online meeting session to take part in texting, video conferencing, virtual whiteboarding, and screen sharing activities. These online meeting sessions may enable data streams of text, audio and/or video signals to be communicated between participant devices in real-time. User experience (UX) is integral to the success of a virtual meeting system. Exceptional UX may enhance the utility, ease of use, and overall efficiency of the virtual meeting system. and help maintain healthy collaborative computing environments.

However, as virtual meetings become more ubiquitous, some meeting participants may experience objectionable comments, including off-topic, offensive, or otherwise inappropriate remarks. Such communications may result in meeting participants feeling uncomfortable and negative towards the UX of the virtual meeting system. Traditional content moderation techniques using filtering tools either over filter or under filter the content thought to be objectionable. Such techniques fail to consider the linguistic nuances among the various meeting participants, leading to inadequate content moderation.

Therefore, it may be advantageous to, among other things, provide a way to predict and block objectionable remarks from a meeting participant before the objectionable remarks are delivered to the other meeting participants. It may be advantageous to combine the functionalities of corpus linguistics analysis and discrete event sequencing to predict whether a next utterance will include an objectionable remark based on a current observed utterance. It may be further advantageous to generate a custom remark prediction model for each meeting participant, where the custom remark prediction model is configured to sequence each utterance to predict objectionable remarks and mitigate the objectionable remarks before the objectionable remarks are delivered to the other meeting participants.

According to an aspect of the invention, there is provided a computer-implemented method to process real-time communications data associated with a virtual meeting application, predict, based on a selected data included in the real-time communications data, that a subsequent data to be received in the real-time communications data will include an objectionable content, and execute a user interface (UI) action in the virtual meeting application to mitigate an impact of the subsequent data including the objectionable content. This aspect may advantageously enable predicting and mitigating an impact of an objectionable content before the objectionable content is delivered in a virtual meeting.

According to another aspect of the invention, there is provided a computer-implemented method to generate a custom remark prediction model for each meeting participant communicating using the virtual meeting application, where the custom remark prediction model comprises a linguistic model and a hidden markov model. The computer-implemented method is further provided to perform the predicting on the selected data using the custom remark prediction model corresponding the meeting participant that sent the selected data. This aspect may advantageously provide customized predictions based on how individual meeting participants communicate.

According to another aspect of the invention, there is provided a computer-implemented method to perform corpus linguistics analysis on historical communications data from each meeting participant to generate the linguistic model associated with each meeting participant, where the linguistic model indicates respective linguistic patterns for each meeting participant. This aspect may advantageously enable learning how individual meeting participants communicate based on how they have communicated in the past.

According to another aspect of the invention, there is provided a computer-implemented method to perform discrete sequence analysis on the historical communications data from each meeting participant to generate the hidden markov model associated with each meeting participant, where the hidden markov model includes transition data and emission data determined based on the linguistic model associated with each meeting participant. This aspect may advantageously enable learning transition data and emission data that is specific to individual meeting participants communicate based on how they have communicated in the past.

According to another aspect of the invention, there is provided a computer-implemented method where the transition data further includes a probability distribution of meeting participant utterances transitioning from an objectionable utterance to another objectionable utterance, from the objectionable utterance to a non-objectionable utterance, from the non-objectionable utterance to the objectionable utterance, and from the non-objectionable utterance to another non-objectionable utterance. This aspect may advantageously enable learning the various transition probabilities between objectionable utterances and non-objectionable utterances.

According to another aspect of the invention, there is provided a computer-implemented method where the transition data further comprises a transition matrix that includes user-specific transition probabilities based on the respective linguistic patterns for each meeting participant. This aspect may advantageously enable incorporating the individual linguistic patterns of each meeting participant into their transition matrix.

According to another aspect of the invention, there is provided a computer-implemented method where processing the real-time communications data associated with the virtual meeting application further includes determining a meeting participant that sent the selected data, and identifying, in a model repository, a custom remark prediction model associated with the meeting participant, where the custom remark prediction model is generated based on historical communications data that is specific to the meeting participant. This aspect may advantageously enable binding a custom remark prediction model to each meeting participant.

According to another aspect of the invention, there is provided a computer-implemented method to apply the custom remark prediction model associated with the meeting participant to the selected data associated with the meeting participant to perform the predicting. This aspect may advantageously enable custom predictions for each meeting participant.

According to another aspect of the invention, there is provided a computer-implemented method to identify a plurality of meeting participants communicating using the virtual meeting application, where the real-time communications data includes respective utterances from the plurality of meeting participants, select a custom remark prediction model for each meeting participant of the plurality of meeting participants, where the custom remark prediction model selected for each meeting participant is generated based on historical communications data that is specific to each meeting participant, and apply the custom remark prediction model to analyze the respective utterances from each meeting participant of the plurality of meeting participants. This aspect may advantageously enable custom predictions for a plurality of meeting participants.

According to another aspect of the invention, there is provided a computer system for remark predictions. The computer system is provided to include one or more processors, one or more computer-readable memories and one or more computer-readable storage media. The computer system is provided to include program instructions, stored on at least one of the one or more storage media for execution by at least one of the one or more processors via at least one of the one or more memories, to process real-time communications data associated with a virtual meeting application. The computer system is also provided to include program instructions, stored on at least one of the one or more storage media for execution by at least one of the one or more processors via at least one of the one or more memories, to predict, based on a selected data included in the real-time communications data, that a subsequent data to be received in the real-time communications data will include an objectionable content. The computer system is further provided to include program instructions, stored on at least one of the one or more storage media for execution by at least one of the one or more processors via at least one of the one or more memories, to execute a user interface (UI) action in the virtual meeting application to mitigate an impact of the subsequent data including the objectionable content. This aspect may advantageously enable a computer system to predict and mitigate an impact of an objectionable content before the objectionable content is delivered in a virtual meeting.

According to another aspect of the invention, there is provided a computer program product for remark predictions. The computer program product is provided to include one or more computer-readable storage media. The computer program product is provided to include program instructions, stored on at least one of the one or more storage media, to process real-time communications data associated with a virtual meeting application. The computer program product is provided to include program instructions, stored on at least one of the one or more storage media, to predict, based on a selected data included in the real-time communications data, that a subsequent data to be received in the real-time communications data will include an objectionable content. The computer program product is provided to include program instructions, stored on at least one of the one or more storage media, to execute a user interface (UI) action in the virtual meeting application to mitigate an impact of the subsequent data including the objectionable content. This aspect may advantageously enable a computer program product to predict and mitigate an impact of an objectionable content before the objectionable content is delivered in a virtual meeting.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

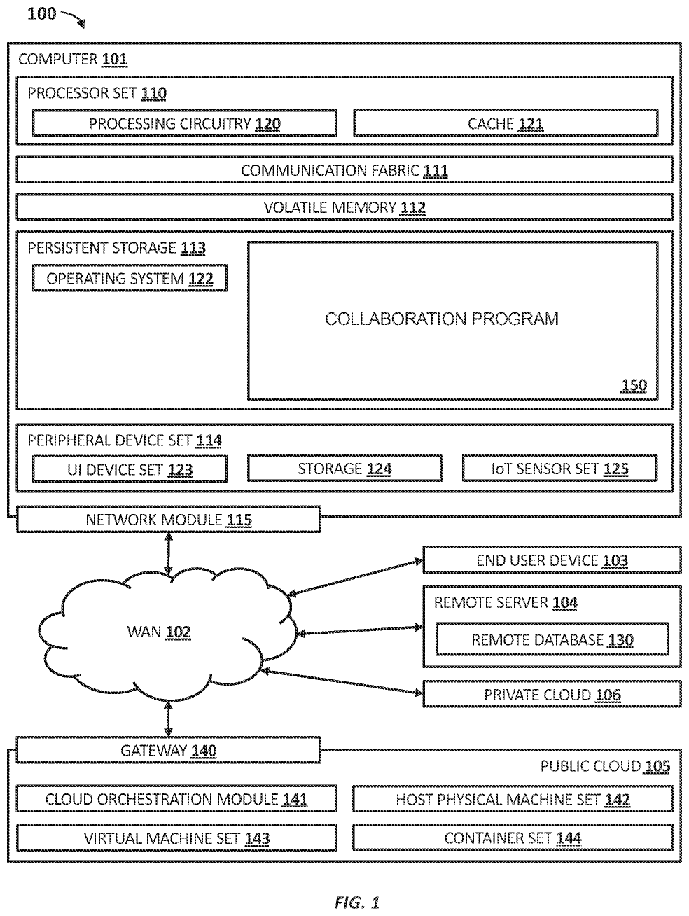

Referring to FIG. 1, a computing environment 100 according to at least one embodiment is depicted. Computing environment 100 contains an example of an environment for the execution of at least some of the computer code involved in performing the inventive methods, such as collaboration program 150. In addition to collaboration program 150, computing environment 100 includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and collaboration program 150, as identified above), peripheral device set 114 (including user interface (UI), device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144. Furthermore, despite only being depicted in computer 101, collaboration program 150 may be stored in and/or executed by, individually or in any combination, EUD 103, remote server 104, public cloud 105, and private cloud 106.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, for illustrative brevity. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface-type operating systems that employ a kernel. The collaboration program 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth® (Bluetooth and all Bluetooth-based trademarks and logos are trademarks or registered trademarks of Bluetooth SIG, Inc. and/or its affiliates) connections, Near-Field Communication (NFC) connections, connections made by cables (such as universal serial bus (USB) type cables), insertion-type connections (for example, secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (for example, embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some embodiments, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

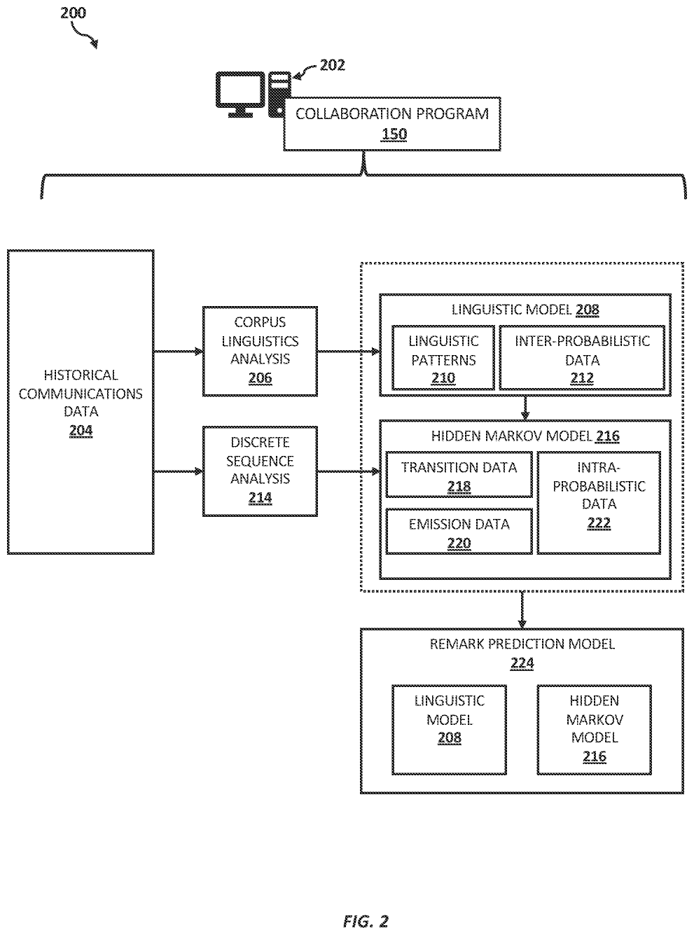

According to the present embodiment, a user using any combination of an EUD 103, remote server 104, public cloud 105, and private cloud 106 may use the collaboration program 150 to generate a custom remark prediction model (e.g., a machine learning model) for each user/meeting participant, to predict and block objectionable remarks from the meeting participant before the objectionable remarks are delivered to the other meeting participants. Embodiments of the present disclosure are explained in more detail below with respect to FIGS. 2 to 5.

Referring now to FIG. 2, a schematic block diagram of a model training environment 200 according to at least one embodiment is depicted. According to one embodiment, the model training environment 200 may include a computer system 202 having a tangible storage device and a processor that is enabled to run the collaboration program 150.

According to one embodiment, the computer system 202 may include one or more components (e.g., computer 101; end user device (EUD) 103; WAN 102) of the computer environment 100 described above with reference to FIG. 1. In one embodiment, the computer system 202 may include one or more computers (e.g., computer 101) which may take the form of a desktop computer, laptop computer, tablet computer, smart phone, smart watch or other wearable computer, mainframe computer, quantum computer or any other form of computer or mobile device now known or to be developed in the future that is capable of running a program, accessing a network, and/or querying a database.

In at least one embodiment, aspects of the computer system 202 may operate in a cloud computing service model, such as Software as a Service (SaaS), Platform as a Service (PaaS), or Infrastructure as a Service (IaaS). In one embodiment, the computer system 202 may also be implemented as a cloud computing deployment model, such as a private cloud, community cloud, public cloud, or hybrid cloud.

In one embodiment, the collaboration program 150 may include a single computer program or multiple program modules or sets of instructions being executed by the processor of the computer system 202. In one embodiment, the collaboration program 150 may include routines, objects, components, units, logic, data structures, and actions that may perform particular tasks or implement particular abstract data types. In one embodiment, the collaboration program 150 may be practiced in distributed cloud computing environments where tasks may be performed by local and/or remote processing devices which may be linked through a communication network (e.g., WAN 102). In at least one embodiment, the collaboration program 150 (e.g., the various modules) may be executed on a single computing device.

According to one embodiment, the model training environment 200 may include a corpus of historical communications data 204. In one embodiment, the corpus of historical communications data 204 (e.g., provide as comma-separate value (CSV) files) may include one or more example user (e.g., meeting participant) utterances (e.g., messages, conversations, discussions) from past naturally produced communications (e.g., chat rooms, virtual meetings). In one embodiment, the corpus of historical communications data 204 may be associated with various topics (e.g., domains). In one embodiment, the collaboration program 150 may retrieve the corpus of historical communications data 204 and partition the corpus of historical communications data 204 into discrete sets (e.g., based on the source of the historical communications data 204, based on the topic discussed in the historical communications data 204).

According to one embodiment, the collaboration program 150 may utilize corpus linguistics analysis 206 including natural language processing (NLP) techniques to analyze the corpus of historical communications data 204 qualitatively and quantitatively. In one embodiment, the corpus linguistics analysis 206 may include parsing the text of the corpus of historical communications data 204, performing part-of speech tagging, topic modeling, and other statistical evaluations.

In one embodiment, the statistical evaluations of the corpus of historical communications data 204 may include determining word and word sequence (e.g., collocation/bi-grams, tri-grams, and colligations) frequencies. For example, an output of the statistical evaluations may include a list of the top words and/or collocations that a user uttered in the corpus of historical communications data 204.

The corpus linguistics analysis 206 may generate a linguistic model 208 for each user (e.g., meeting participant). In one embodiment, the linguistic model 208 may include data indicative of a user's linguistic patterns 210 (e.g., how the user speaks/writes). In one embodiment, the linguistic patterns 210 may be used to determine the proportion of words the user utilizes that are objectionable versus non-objectionable. The linguistic model 208 may also include inter-probabilistic data 212 determined based on the user's linguistic patterns 210. In one embodiment, the inter-probabilistic data 212 may be used to determine the probability of phrases or sequences of words (e.g., collocations) that are objectionable versus non-objectionable.

According to one embodiment, objectionable may refer to utterances that are off-topic, offensive, or inappropriate, and non-objectionable may refer to utterances that are on-topic, non-offensive, or appropriate. In one embodiment, the collaboration program 150 may determine if the utterance is objectionable (e.g., offensive/non-offensive or inappropriate/appropriate) based on comparing the utterance to a word graph of offensive/inappropriate words and phrases. In one embodiment, if the collaboration program 150 is implemented within a company's communication system, the collaboration program 150 may access the company's business conduct guidelines to determine if the utterance falls within the company's values, culture, and/or ethos. In one embodiment, the collaboration program 150 may determine if the utterance is objectionable (e.g., on-topic/off-topic) based on comparing the utterance to a word graph associated with a given domain (e.g., words associated with the domain of sustainable computing).

According to one embodiment, the collaboration program 150 may utilize discrete sequence analysis 214 and the linguistic model 208 to generate a hidden markov model 216 associated with the user. Generally, the hidden markov model 216 may enable computing a joint probability of a set of hidden states given a series of observations. In aspects of the present disclosure, the series of hidden states may include user utterance categorizations that may not be observed directly. In one embodiment, the collaboration program 150 may implement two hidden states in the hidden markov model 216 such that user utterances may be classified as either an objectionable utterance (e.g., objectionable state) or a non-objectionable utterance (e.g., non-objectionable state). In aspects of the present disclosure, the series of observations may include the user utterances in a virtual meeting that may be observed directly. As such, in one embodiment, the hidden markov model 216 may enable computing the probability of a user's utterance transitioning between the various permutations of objectionable and non-objectionable states in real-time (e.g., as each utterance is spoken or typed). Accordingly, as each user utterance is passed through the hidden markov model 216, the hidden markov model 216 may predict whether the next user utterance will be an objectionable or non-objectionable utterance.

According to one embodiment, the hidden markov model 216 may be generated using parameters such as transition data 218 and emission data 220. In one embodiment, the transition data 218 may indicate the set of all possible hidden states (e.g., utterance states) being modeled and the probability of one hidden state transitioning (e.g., changing) to another hidden state. The transition data 218 may include a memoryless markov property such that a future hidden state (e.g., subsequent hidden state) may be determined (e.g., based on a conditional probability distribution) from a current hidden state. In one embodiment, the transition probabilities may be captured in a transition matrix. In the present disclosure, the transition data 218 may include two hidden states and the transition matrix may represent the transition probabilities between objectionable utterances (e.g., objectionable state) and non-objectionable utterances (e.g., non-objectionable state). For example, the transition matrix of the transition data 218 may indicate the probability of user utterances (e.g., meeting participant utterances) transitioning from an objectionable utterance to another objectionable utterance, from an objectionable utterance to a non-objectionable utterance, from a non-objectionable utterance to an objectionable utterance, and from a non-objectionable utterance to another non-objectionable utterance.

In one embodiment, the emission data 220 may be associated with the series of observations (e.g., user utterances) and indicates the probabilities of observations at a particular time given a hidden state at that same particular time. The observation probabilities (e.g., emission probabilities) representing the relationship between hidden states and observations may be captured in an emission matrix. For example, the emission probabilities may be used to infer an utterance state (e.g., non-objectionable utterance or objectionable utterance) based on an input user utterance.

According to one embodiment, the collaboration program 150 may use the corpus of historical communications data 204 to learn the transition matrix of the transition data 218 and the emission matrix of the emission data 220. Then, the transition matrix and the emission matrix may be set as the prior beliefs of the hidden markov model 216 when predicting based on real-time communications data. This form of unsupervised learning may result in the hidden markov model 216 being faster and more light-weight (e.g., less lines of code) compared to traditional classification models generated based on supervised machine learning techniques that need to incorporate large amounts of training data into the model.

According to one embodiment, the transition data 218 and the emission data 220 may be augmented with data from the linguistic model 208 such that the hidden markov model 216 may learn (e.g., prior belief) how individual users naturally speak/write. In one embodiment, the linguistic model 208 may include a first pool of objectionable utterances and a second pool of non-objectionable utterances associated with each user. In one embodiment, the collaboration program 150 may calculate the probability distribution of the user including utterances from each of those two pools and incorporate this information when generating the transition matrix and the emission matrix.

In one embodiment, the linguistic model 208 may indicate the list of the top collocations that a user frequently uses based on the corpus of historical communications data 204. In one embodiment, the collaboration program 150 may then generate the transition matrix by analyzing the list of the top collocations to determine the user-specific transition probabilities between objectionable utterances and non-objectionable utterances. For example, if user A utters more objectionable phrases than user B, a transition matrix that is specific to user A may indicate a higher probability of transitioning from a non-objectionable utterance to an objectionable utterance relative to a transition matrix that is specific to user B.

In one embodiment, the linguistic model 208 may include a list of the most common terms uttered by the user and the corresponding collocates (e.g., words immediately surrounding the term). This collocation data may provide further context when determining the utterance state (e.g., non-objectionable utterance or objectionable utterance) by indicating which of the most common terms uttered by the user are associated with non-objectionable utterances or objectionable utterances. This collocation data may also indicate which term in the series of terms (e.g., in the collocation) led to the transition from non-objectionable utterance to objectionable utterance. In one embodiment, the collocation data may be incorporated into the transition matrix (e.g., as a matrix multiplier) to set user-specific transition probabilities in the prior belief of the hidden markov model 216. In at least one embodiment, the hidden markov model 216 may also include intra-probabilistic data 222 which may be generated using the collocation data. In one embodiment, the intra-probabilistic data 222 may indicate the probability of the transition states (e.g., utterance states) changing between single word utterances.

According to one embodiment, the collaboration program 150 may generate the remark prediction model 224 based on the outputs of the corpus linguistics analysis 206 (e.g., linguistic model 208) and the discrete sequence analysis 214 (e.g., hidden markov model 216). As such, the remark prediction model 224 may include the linguistic model 208 and the hidden markov model 216. It is contemplated that the non-obvious combination of the corpus linguistics analysis 206 and the discrete sequence analysis 214 may provide higher fidelity state predictions compared to only using corpus linguistics analysis 206 or discrete sequence analysis 214 because the combination utilizes the linguistic patterns 210 of the user to generate transition data 218 (e.g., transition matrix) and emission data 220 (e.g., emission matrix) that is user-specific.

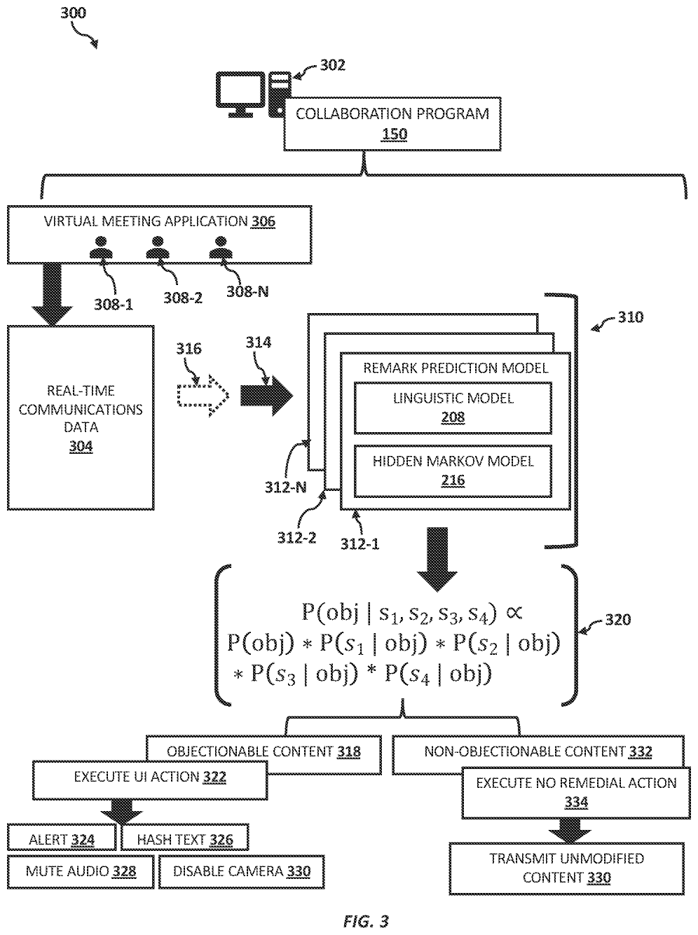

Referring now to FIG. 3, a schematic block diagram of a virtual meeting environment 300 according to at least one embodiment is depicted. According to one embodiment, the virtual meeting environment 300 may include a computer system 302 having a tangible storage device and a processor that is enabled to run the collaboration program 150. According to one embodiment, the computer system 302 may include one or more components (e.g., computer 101; end user device (EUD) 103; WAN 102) of the computer environment 100 described above with reference to FIG. 1 and one or more components of the model training environment 200 discussed above with reference to FIG. 2.

According to one embodiment, the collaboration program 150 may process real-time communications data 304 associated with a virtual meeting application 306. In one embodiment, the virtual meeting environment 300 may include a plurality of meeting participants 308-1, 308-2, 308-N that communicate in real-time using the virtual meeting application 306 running on their respective user devices (e.g., EUD 103). The collaboration program 150 may interact with the virtual meeting application 306 to implement the present disclosure. In one embodiment, the collaboration program 150 may be implemented as a client component or front-end layer of the virtual meeting application 306.

According to one embodiment, computer system 302 may include a model repository 310 (e.g., remote database 130) storing a plurality of remark prediction models 312-1, 312-2, 312-N (e.g., remark prediction model 224). Each of the plurality of remark prediction models 312-1, 312-2, 312-N may correspond to a respective meeting participant of the plurality of meeting participants 308-1, 308-2, 308-N (if the meeting participant opts into the collaboration program 150). For example, the collaboration program 150 may generate the remark prediction model 312-1 using historical communications data 204 that is specific to meeting participant 308-1 and may generate the remark prediction model 312-2 using historical communications data 204 that is specific to meeting participant 308-2 (e.g., as described previously with reference to FIG. 2). By customizing the plurality of remark prediction models 312-1, 312-2, 312-N to the respective meeting participants 308-1, 308-2, 308-N, the collaboration program 150 may enable higher fidelity predictions relative to predictions using a generic remark prediction model for all of the plurality of meeting participants. In one embodiment, the plurality of remark prediction models 312-1, 312-2, 312-N may run simultaneously in the virtual meeting environment 300 and analyze the real-time communications data 304 that corresponds to the respective meeting participant. In one embodiment, the collaboration program 150 may deploy the model repository 310 as a container storing all of the plurality of remark prediction models 312-1, 312-2, 312-N. In at least one embodiment, the collaboration program 150 may generate a single light-weight container storing the respective remark prediction model for each of the plurality of meeting participants 308-1, 308-2, 308-N running in the background.

The following description of FIG. 3 will be made with reference to an exemplary meeting participant 308-N and an exemplary remark prediction model 312-N that corresponds to the meeting participant 308-N. However, it is contemplated that the described features may similarly apply to the embodiments including the plurality of meeting participants 308-1, 308-2, 308-N interacting with the plurality of remark prediction models 312-1, 312-2, 312-N that run simultaneously in the virtual meeting environment 300.

According to one embodiment, the collaboration program 150 may analyze the real-time communications data 304 generated by the meeting participant 308-N (e.g., words spoken or typed into the virtual meeting application 306). In one embodiment, the collaboration program 150 may feed a selected data 314 from the real-time communications data 304 into the remark prediction model 312-N to predict whether a subsequent data 316 to be received in the real-time communications data 304 will include an objectionable content 318. In one embodiment, the selected data 314 may include a current utterance of the meeting participant 308-N and the subsequent data 316 may include a next utterance of the meeting participant 308-N that has not yet been delivered to the other meeting participants 308-1, 308-2.

According to one embodiment, the collaboration program 150 may determine the meeting participant 308-N from the plurality of meeting participants 308-1, 308-2, 308-N that sent the selected data 314. Then, the collaboration program 150 may identify, in the model repository 310, the remark prediction model 312-N associated with the meeting participant 308-N (e.g., a custom remark prediction model). In one embodiment, the remark prediction model 312-N may be generated using the historical communications data 204 that is specific to meeting participant 308-N. In one embodiment, the collaboration program 150 may apply the remark prediction model 312-N associated with the meeting participant 308-N to the selected data 314 associated with the meeting participant 308-N to perform the prediction (e.g., probability calculation of the subsequent data 316 including the objectionable content 318).

According to one embodiment, the remark prediction model 312-N may implement the hidden markov model 216 (FIG. 2) to determine a current utterance state (e.g., highest probability hidden state) associated with current utterance (e.g., current observation) in the selected data 314. In one embodiment, the hidden markov model 216 may use an emission matrix (e.g., emission data 220) to determine the current utterance state from the current utterance. In one embodiment, the hidden markov model 216 may then use a transition matrix (e.g., transition data 218) to predict a next utterance state based on the current utterance state. As such, the remark prediction model 312-N may generate a prediction 320 indicating whether a next utterance in the subsequent data 316 will include the objectionable content 318 (e.g., objectionable utterance state) before the subsequent data 316 is delivered to the other meeting participants 308-1, 308-2. In one embodiment, the analysis by the hidden markov model 216 may be augmented with user-specific data (e.g., linguistic patterns 210; inter-probabilistic data 212) from the linguistic model 208 to provide a high fidelity state prediction 320 that is specific to meeting participant 308-N.

Responsive to determining that the subsequent data 316 may include objectionable content 318 (e.g., objectionable state), the collaboration program 150 may execute a user interface (UI) action 322 in the virtual meeting application 306 to mitigate an impact of the subsequent data 316 including the objectionable content 318. In one embodiment, the UI action 322 may include transmitting an alert 324 (e.g., warning) to the meeting participant 308-N that sent the selected data 314. For example, the collaboration program 150 may transmit the alert 324 to the meeting participant 308-N if the prediction 320 indicates that the next utterance (e.g., in the subsequent data 316) may include an off-topic content. In one embodiment, the UI action 322 may include a hash text 326 action to blur out a text communication in the subsequent data 316 including the objectionable content 318. In one embodiment, the UI action 322 may include a mute audio 328 action and/or a disable camera 330 action to mute the subsequent data 316 if it includes the objectionable content 318 in an audio and/or video data format.

In at least one embodiment, the collaboration program 150 may predict, based on the selected data 314 included in the real-time communications data 304, that the subsequent data 316 to be received in the real-time communications data 304 will include non-objectionable content 332 (e.g., non-objectionable state). In other words, the hidden markov model 216 may use the transition matrix (e.g., transition data 218) to predict, based on the current utterance state, that the next utterance state will be a non-objectionable state. Responsive to determining that the subsequent data 316 may include non-objectionable content 332 (e.g., non-objectionable state), the collaboration program 150 may execute no remedial action 334. In one embodiment, the collaboration program 150 may transmit unmodified content 336 to the other meeting participants 308-1, 308-2. In one embodiment, the unmodified content 336 may include the subsequent data 316 that was predicted to include non-objectionable content 332.

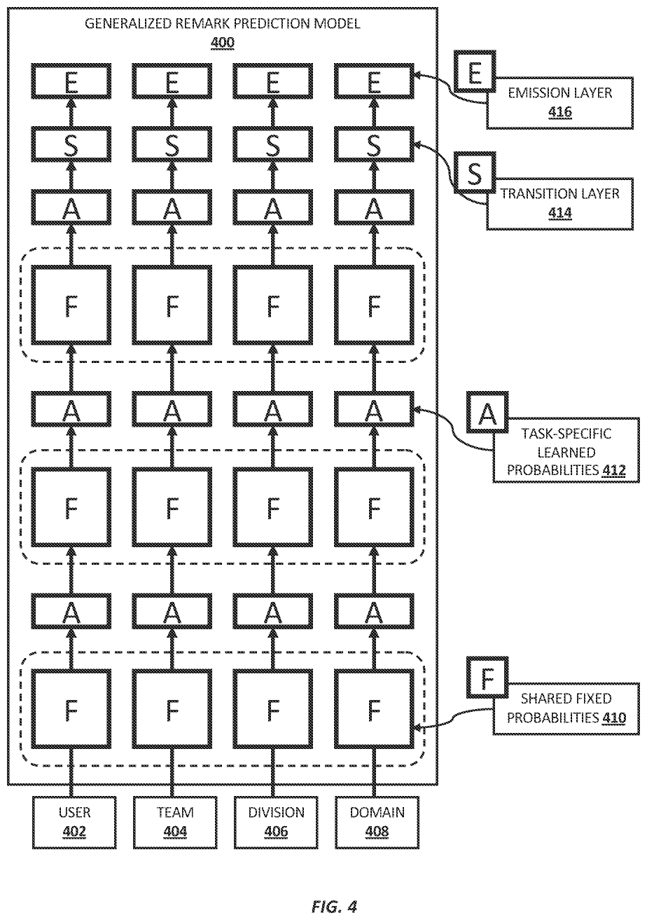

Referring now to FIG. 4, a schematic block diagram of a generalized remark prediction model 400 according to at least one embodiment is depicted.

According to one embodiment, the generalized remark prediction model 400 may include a multi-tiered model system. In one embodiment, model 400 may be configured to analyze a broad range of linguistic styles and use such variations as prior belief across a wider range of users 402, teams 404, divisions 406, and domains 408. According to one embodiment, the multi-tiered model system may include a user 402 version of model 400 that may be bound to a specific meeting participant. In one embodiment, the multi-tiered model system may include a team 404 layer of the model 400 that may be bound to a team. In one embodiment, the multi-tiered model system may include a division 406 layer of the model 400 that may be bound to a division (e.g., multiple teams). In one embodiment, the multi-tiered model system may include a domain 408 layer of the model 400 that may be bound to a domain specific meeting.

According to one embodiment, the generalized remark prediction model 400 may include a shared fixed probabilities 410 layer including co-occurrences of terms that are spoken at regular intervals such that their appearance does not deviate in terms of their probability of occurring over time. For example, the shared fixed probabilities 410 layer in the team 404 version of the model 400 may capture the linguistic similarities when multiple users talk within the team. In one embodiment, the generalized remark prediction model 400 may include a task-specific learned probabilities layer 412. The task-specific learned probabilities layer 412 may include utterances related to a given task (e.g., the process of training an artificial intelligence model is associated with task-specific language). In one embodiment, the generalized remark prediction model 400 may include a transition layer 414 that may provide the probability distribution of transitioning between hidden states. In one embodiment, the generalized remark prediction model 400 may include an emission layer 416 that may indicate the probabilities of observations at a particular time given a hidden state at that same particular time.

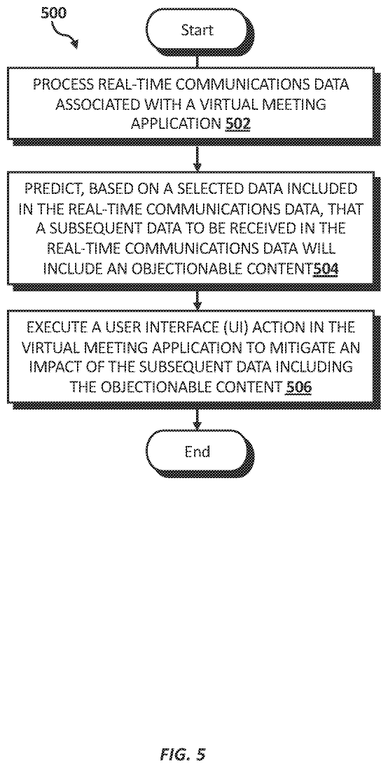

FIG. 5 is an operational flowchart illustrating an exemplary remark prediction process 500 used by the collaboration program 150 according to at least one embodiment is depicted. FIG. 5 provides a description of process 500 with reference to the model generating environment 200 (FIG. 2) and the virtual meeting environment 300 (FIG. 3).

At 502, real-time communications data associated with a virtual meeting application is processed. According to one embodiment, the collaboration program 150 may be automatically enabled at the start of a virtual meeting. In one embodiment, the virtual meeting may include a plurality of meeting participants that communicate in real-time using the virtual meeting application running on their respective user devices. In one embodiment, the collaboration program 150 may be implemented as a client component or front-end layer of the virtual meeting application. In one embodiment, any real-time communications data in audio format may be converted to text prior to prediction analysis.

At 504, a prediction is performed, based on a selected data included in the real-time communications data, where the prediction indicates that a subsequent data to be received in the real-time communications data will include an objectionable content. According to one embodiment, the collaboration program may generate a custom remark prediction model for each meeting participant communicating using the virtual meeting application. In one embodiment, the custom remark prediction model may include a linguistic model and a hidden markov model.

According to one embodiment, the collaboration program may perform corpus linguistics analysis on historical communications data from each meeting participant to generate the linguistic model associated with each meeting participant. In one embodiment, the linguistic model may be provided in the custom remark prediction model. In one embodiment, the linguistic model may include respective linguistic patterns for each meeting participant. According to one embodiment, the collaboration program may perform discrete sequence analysis on the historical communications data from each meeting participant to generate the hidden markov model associated with each meeting participant. In one embodiment, the hidden markov model may include transition data and emission data determined based on the linguistic model associated with each meeting participant. In one embodiment, the hidden markov model may be provided in the custom remark prediction model.

According to one embodiment, the collaboration program may determine the meeting participant from the plurality of meeting participants that sent the selected data. Then, the collaboration program may identify, in a model repository, the custom remark prediction model associated with the meeting participant. In one embodiment, the collaboration program may apply the custom remark prediction model associated with the meeting participant to the selected data associated with the meeting participant to perform the prediction (e.g., probability calculation of the subsequent data including the objectionable content).

According to one embodiment, the custom remark prediction model may implement the hidden markov model to determine a current utterance state (e.g., highest probability hidden state) associated with current utterance (e.g., current observation) in the selected data. In one embodiment, the hidden markov model may use an emission matrix (e.g., emission data) to determine the current utterance state from the current utterance. In one embodiment, the hidden markov model may then use a transition matrix (e.g., transition data) to predict a next utterance state based on the current utterance state. As such, the remark prediction model may generate a prediction indicating whether a next utterance in the subsequent data will include the objectionable content (e.g., objectionable utterance state) before the subsequent data is delivered to the other meeting participants in the virtual meeting.

Thereafter at 506, a user interface (UI) action is executed in the virtual meeting application to mitigate an impact of the subsequent data including the objectionable content. Responsive to determining that the subsequent data may include objectionable content (e.g., objectionable state), the collaboration program 150 may execute a (UI) action in the virtual meeting application to mitigate an impact of the subsequent data including the objectionable content. In one embodiment, the UI action may include transmitting an alert (e.g., warning) to the meeting participant that sent the selected data. For example, the collaboration program 150 may transmit the alert to the meeting participant if the prediction indicates that the next utterance (e.g., in the subsequent data) may include an off-topic content. In one embodiment, the UI action may include a hash text action to blur out a text communication in the subsequent data including the objectionable content. In one embodiment, the UI action may include a mute audio action and/or a disable camera action to mute the subsequent data if it includes the objectionable content in an audio and/or video data format.

It is contemplated that the collaboration program 150 may provide several advantages and/or improvements to the technical field of collaborative computing sessions. The collaboration program 150 may also improve the functionality of a computer because the collaboration program 150 may enable the computer to predict and block objectionable remarks from a meeting participant before the objectionable remarks are delivered to the other meeting participants. The collaboration program 150 may also enable the computer to combine the functionalities of corpus linguistics analysis and discrete event sequencing to predict whether a next utterance will include an objectionable remark based on a current observed utterance. The collaboration program 150 may also enable the computer to generate a custom remark prediction model for each user/meeting participant, where the custom remark prediction model may be configured to sequence each utterance to predict objectionable remarks and mitigate the objectionable remarks before the objectionable remarks are delivered to the other meeting participants.

It may be appreciated that FIGS. 2 to 5 provide only an illustration of one embodiment and do not imply any limitations with regard to how different embodiments may be implemented. Many modifications to the depicted embodiment(s) may be made based on design and implementation requirements.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
processing real-time communications data associated with a virtual meeting application;
predicting, based on a selected data included in the real-time communications data, that a subsequent data to be received in the real-time communications data will include an objectionable content; and
executing a user interface (UI) action in the virtual meeting application to mitigate an impact of the subsequent data including the objectionable content.

2. The computer-implemented method of claim 1, further comprising:
generating a custom remark prediction model for each meeting participant communicating using the virtual meeting application, wherein the custom remark prediction model comprises a linguistic model and a hidden markov model; and
performing the predicting on the selected data using the custom remark prediction model corresponding to a meeting participant that sent the selected data.

3. The computer-implemented method of claim 2, further comprising:
performing corpus linguistics analysis on historical communications data from each meeting participant to generate the linguistic model of the custom remark prediction model, wherein the linguistic model indicates respective linguistic patterns for each meeting participant.

4. The computer-implemented method of claim 3, further comprising:
performing discrete sequence analysis on the historical communications data from each meeting participant to generate the hidden markov model of the custom remark prediction model, wherein the hidden markov model includes transition data and emission data determined based on the linguistic model associated with each meeting participant.

5. The computer-implemented method of claim 4, wherein the transition data further comprises a probability distribution of meeting participant utterances transitioning from an objectionable utterance to another objectionable utterance, from the objectionable utterance to a non-objectionable utterance, from the non-objectionable utterance to the objectionable utterance, and from the non-objectionable utterance to another non-objectionable utterance.

6. The computer-implemented method of claim 4, wherein the transition data further comprises a transition matrix that includes user-specific transition probabilities based on the respective linguistic patterns for each meeting participant.

7. The computer-implemented method of claim 1, wherein processing the real-time communications data associated with the virtual meeting application further comprises:
determining a meeting participant that sent the selected data; and
identifying, in a model repository, a custom remark prediction model associated with the meeting participant, wherein the custom remark prediction model is generated based on historical communications data that is specific to the meeting participant.

8. The computer-implemented method of claim 7, further comprising:
applying the custom remark prediction model associated with the meeting participant to the selected data associated with the meeting participant to perform the predicting.

9. The computer-implemented method of claim 1, further comprising:
identifying a plurality of meeting participants communicating using the virtual meeting application, wherein the real-time communications data includes respective utterances from the plurality of meeting participants;
selecting a custom remark prediction model for each meeting participant of the plurality of meeting participants, wherein the custom remark prediction model selected for each meeting participant is generated based on historical communications data that is specific to each meeting participant; and
applying the custom remark prediction model to analyze the respective utterances from each meeting participant of the plurality of meeting participants.

10. A computer system for remark predictions, the computer system comprising:
one or more processors, one or more computer-readable memories and one or more computer-readable storage media;
program instructions, stored on at least one of the one or more storage media for execution by at least one of the one or more processors via at least one of the one or more memories, to process real-time communications data associated with a virtual meeting application;
program instructions, stored on at least one of the one or more storage media for execution by at least one of the one or more processors via at least one of the one or more memories, to predict, based on a selected data included in the real-time communications data, that a subsequent data to be received in the real-time communications data will include an objectionable content; and
program instructions, stored on at least one of the one or more storage media for execution by at least one of the one or more processors via at least one of the one or more memories, to execute a user interface (UI) action in the virtual meeting application to mitigate an impact of the subsequent data including the objectionable content.

11. The computer system of claim 10, further comprising:
program instructions, stored on at least one of the one or more storage media for execution by at least one of the one or more processors via at least one of the one or more memories, to generate a custom remark prediction model for each meeting participant communicating using the virtual meeting application, wherein the custom remark prediction model comprises a linguistic model and a hidden markov model; and
program instructions, stored on at least one of the one or more storage media for execution by at least one of the one or more processors via at least one of the one or more memories, to perform the predicting on the selected data using the custom remark prediction model corresponding to a meeting participant that sent the selected data.

12. The computer system of claim 11, further comprising:
program instructions, stored on at least one of the one or more storage media for execution by at least one of the one or more processors via at least one of the one or more memories, to perform corpus linguistics analysis on historical communications data from each meeting participant to generate the linguistic model of the custom remark prediction model, wherein the linguistic model indicates respective linguistic patterns for each meeting participant.

13. The computer system of claim 12, further comprising:
program instructions, stored on at least one of the one or more storage media for execution by at least one of the one or more processors via at least one of the one or more memories, to perform discrete sequence analysis on the historical communications data from each meeting participant to generate the hidden markov model of the custom remark prediction model, wherein the hidden markov model includes transition data and emission data determined based on the linguistic model associated with each meeting participant.

14. The computer system of claim 13, wherein the transition data further comprises a probability distribution of meeting participant utterances transitioning from an objectionable utterance to another objectionable utterance, from the objectionable utterance to a non-objectionable utterance, from the non-objectionable utterance to the objectionable utterance, and from the non-objectionable utterance to another non-objectionable utterance.

15. The computer system of claim 13, wherein the transition data further comprises a transition matrix that includes user-specific transition probabilities based on the respective linguistic patterns for each meeting participant.

16. The computer system of claim 10, wherein:
the program instructions to process the real-time communications data associated with the virtual meeting application further comprises:
program instructions, stored on at least one of the one or more storage media for execution by at least one of the one or more processors via at least one of the one or more memories, to determine a meeting participant that sent the selected data; and
program instructions, stored on at least one of the one or more storage media for execution by at least one of the one or more processors via at least one of the one or more memories, to identify, in a model repository, a custom remark prediction model associated with the meeting participant, wherein the custom remark prediction model is generated based on historical communications data that is specific to the meeting participant.

17. The computer system of claim 16, further comprising:
program instructions, stored on at least one of the one or more storage media for execution by at least one of the one or more processors via at least one of the one or more memories, to apply the custom remark prediction model associated with the meeting participant to the selected data associated with the meeting participant to perform the predicting.

18. The computer system of claim 10, further comprising:
program instructions, stored on at least one of the one or more storage media for execution by at least one of the one or more processors via at least one of the one or more memories, to identify a plurality of meeting participants communicating using the virtual meeting application, wherein the real-time communications data includes respective utterances from the plurality of meeting participants;
program instructions, stored on at least one of the one or more storage media for execution by at least one of the one or more processors via at least one of the one or more memories, to select a custom remark prediction model for each meeting participant of the plurality of meeting participants, wherein the custom remark prediction model selected for each meeting participant is generated based on historical communications data that is specific to each meeting participant; and
program instructions, stored on at least one of the one or more storage media for execution by at least one of the one or more processors via at least one of the one or more memories, to apply the custom remark prediction model to analyze the respective utterances from each meeting participant of the plurality of meeting participants.

19. A computer program product for remark predictions, the computer program product comprising:
one or more computer-readable storage media;
program instructions, stored on at least one of the one or more storage media, to process real-time communications data associated with a virtual meeting application;
program instructions, stored on at least one of the one or more storage media, to predict, based on a selected data included in the real-time communications data, that a subsequent data to be received in the real-time communications data will include an objectionable content; and
program instructions, stored on at least one of the one or more storage media, to execute a user interface (UI) action in the virtual meeting application to mitigate an impact of the subsequent data including the objectionable content.

20. The computer program product of claim 19, further comprising:
program instructions, stored on at least one of the one or more storage media, to generate a custom remark prediction model for each meeting participant communicating using the virtual meeting application, wherein the custom remark prediction model comprises a linguistic model and a hidden markov model; and
program instructions, stored on at least one of the one or more storage media, to perform the predicting on the selected data using the custom remark prediction model corresponding to a meeting participant that sent the selected data.
